(19) United States
(12) Patent Application Publication
(10) Pub. No.: US 2009/0234548 A1
(43) Pub. Date: Sep. 17, 2009

(54) HOLDING BRAKE FOR TRACK-BOUND MOTOR VEHICLES

(75) Inventors: Hans Bergner, Erlangen (DE); Thilo Hoffmann, Graz (AT); Andreas Jöckel, Nürnberg (DE); Martin Teichmann, Graz (AT)

Correspondence Address: HENRY M FEIEREISEN, LLC;HENRY M FEIEREISEN, 708 THIRD AVENUE, SUITE 1501, NEW YORK, NY, 10017, US

(73) Assignee: Siemens Aktiengesellschaft, Munchen (DE)

(21) Appl. No.: 11/909,016

(22) PCT Filed: Mar. 15, 2006
(86) PCT No.: PCT/EP2006/060771

§ 371 Date: Nov. 7, 2008

(30) Foreign Application Priority Data
Mar. 18, 2005 (DE) 10 2005 012 670.7

(51) Int. Cl. G06F 19/00; B60L 7/00

(52) U.S. Cl. 701/70; 188/160

(57) ABSTRACT

The invention relates to a holding brake for track-bound motor vehicles (1) with the holding brake being realized by means of at least one electric machine (2) which has a rotor and a stator. A control system for the electric machine is hereby provided to so control the operation of the electric machine (2) that the position of the rotor in the stator remains constant when exposed to an external torque. In other words, the electric motor (2) is used as holding brake instead of a pneumatic holding brake. In this way, the holding brake is advantageously not subject to any wear since the holding forces are produced magnetically and not by mechanical forces. In addition, no noise is generated by the use of the holding brake according to the invention. Furthermore, a starting jolt is prevented, when the electric motor (2) used as a holding brake is also used as a drive motor.

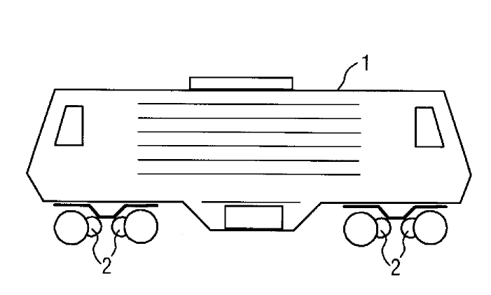

This invention relates to a holding brake for track-bound motor vehicles, wherein the holding brake is realized by means of at least one electric machine which includes a rotor and a stator.

Motor vehicles are used in railroad traffic to pull freight cars or passenger cars. Electrically propelled and track-bound motor vehicles that are approved for passenger transportation have a pneumatically, hydraulically, or electrically operated mechanical (secondary) brake in addition to a regenerative electric service brake. The regenerative electric service brake may be operated by a PM synchronous motor of the motor vehicle having a rotor with permanent magnets and operating as generator. At operation, the motor vehicle can be brought to a halt by using only the regenerative electric service brake. The mechanical brake is applied at the train station or at a station stop, as soon as the vehicle is at a standstill. The mechanical brake is then utilized as holding brake. The operation of the holding brake in the train station has to be highly reliable because the vehicle may not move under any circumstances during passenger embarking or disembarking.

EP 0 875 433 B1 discloses how a mechanical holding brake can be structured for rail vehicles. U.S. Pat. No. 5,564,795 discloses how a pneumatic holding brake and its control system can be structured. In both cases, the holding brakes have a mechanically complex structure.

Actuation and release of a pneumatic holding brake for track-bound motor vehicles requires the use of much compressed air which is difficult to generate by an electrically-operated compressor and only with poor efficiency. In other words, the operation of the pneumatic holding brake consumes much energy. Furthermore, passenger comfort is impaired, when the mechanical holding brake is released because a jolt is produced during release and simultaneous start of the track-bound vehicle. The brake block and the mechanical brake unit of the mechanical holding brake, and optionally also the compressor of a pneumatic holding brake may wear off. Moreover, noise develops when the pneumatic holding brake is actuated or released.

The invention is therefore based on the object to provide a holding brake for track-bound motor vehicles, which consumes less energy than a pneumatic holding brake and which ensures greater riding comfort. Furthermore, the holding brake according to the invention should withstand wear and develop comparably little noise.

This object is solved in accordance with the invention by providing a control system of the electric machine to so control the operation of the electric machine that the position of the rotor in the stator remains constant even when exposed to an external torque.

In other words, an electric machine is now used as holding brake instead of a mechanical holding brake. As a result, no wear is advantageously encountered during operation of the holding brake according to the invention since the holding forces are produced magnetically and not by mechanical forces. It is further advantageous that the operation of the holding brake according to the invention does not generate any noise. Furthermore, no starting jolt is encountered, when the electric machine, used as holding brake, is used also as drive motor.

According to a further advantageous configuration of the invention, a position control is associated to the control system of the electric machine for adjusting the rotor to a desired position. In this way, the standstill of the track-bound motor vehicle is ensured in an especially beneficial manner.

The angular position of the rotor may be determined by a rotor position encoder. As an alternative, the angular position of the rotor may also be determined on the basis of electric variables with the assistance of a rotor position model, e.g. by evaluating magnetic asymmetries, caused by the position of the rotor in the stator. Electric variables, like e.g. the input voltage or the current flowing in the electric machine, are evaluated. This evaluation is based on position-dependent differences in inductances of the rotor. Especially with the assistance of the afore-stated options for determining the angular position of the rotor, the position control can be realized in an especially precise manner. When the angular position is determined on the basis of the rotor position model, the need for a rotor position encoder may advantageously be eliminated.

Furthermore, a converter power section is advantageously associated to the control system. The electric machine may be configured, e.g. as asynchronous motor or also as PM synchronous motor with permanent magnets upon the armature. In the latter case, the holding brake may be realized in a particularly robust manner by feeding the stator of the PM synchronous motor with direct current in order to effect a braking action. The direct current may be provided by a battery or, as an alternative, by a rectifier.

The invention as well as further advantageous embodiments of the invention according to the features of the dependent claims will now be described in greater detail with reference to an exemplary embodiment shown schematically in the drawing, without limiting the invention to this exemplary embodiment. It is shown in:

FIGURE a track-bound motor vehicle.

The service brake of a track-bound motor vehicle 1 is still realized entirely by an electric motor operating as a generator. The drive may be implemented with the same electric machine 2 or with a further electric machine. A fail-safe brake is realized through regenerative supply of a PM synchronous motor to a rheostatic emergency braking, when the controlled drive and brake system fails. This PM synchronous motor may correspond with the electric machine used as drive, or also with the electric machine used as service brake.

In accordance with the invention, an electric machine 2 is used as holding brake instead of a mechanical brake. This electric machine may also be used as service brake, fail-safe brake, or as drive.

The electric machine 2 is hereby so controlled as to keep the position of the rotor in the stator constant even when exposed to an external torque. The electric machine 2 is so controlled by a position control as to adjust the rotor to a desired position. An optimal execution of the position control requires information about the actual position of the rotor. This can be determined by a rotor position encoder or by means of a rotor position model. The rotor position model uses electric measuring variables. Evaluation of the rotor position model by means of electric variables may be based on the evaluation of magnetic asymmetries of the rotor or on the evaluation of the position-dependent differences in inductance of the rotor.

The electric machine 2 is supplied with power during operation as holding brake by means of a converter power section. The electric machine 2 may further be configured as asynchronous motor or also as PM synchronous motor.

In the latter case, a holding brake may easily be realized by supplying the PM synchronous motor with direct current to effect a braking action. The direct current may be provided by a battery or, as an alternative, by a rectifier.

1.-19. (canceled)

20. A holding brake for a track-bound motor vehicle, with the holding brake being realized by at least one electric machine which has a rotor and a stator, said holding brake including a control system to so control the operation of the electric machine that the position of the rotor in the stator remains constant when exposed to an external torque.

21. The holding brake of claim 20, further comprising a position control operatively connected to the control system for adjusting the rotor to a desired position.

22. The holding brake of claim 20, further comprising a rotor position encoder operatively connected to the control system for determining an angular position of the rotor.

23. The holding brake of claim 20, further comprising a means operatively connected to the control system for determining an angular position of the rotor on the basis of electric variables with the assistance of a rotor position model.

24. The holding brake of claim 23, wherein the means is constructed to determine the angular position of the rotor on the basis of an evaluation of magnetic asymmetries.

25. The holding brake of claim 23, wherein the means is constructed to determine the angular position of the rotor on the basis of position-dependent differences in inductance of the rotor.

26. The holding brake of claim 20, further comprising a converter power section operatively connected to the control system for supply of power to the electric machine.

27. The holding brake of claim 20, wherein the electric machine is an asynchronous motor.

28. The holding brake of claim 20, wherein the electric machine is a PM synchronous motor.

29. The holding brake of claim 28, wherein the control system of the electric machine has an operating mode at which the stator of the PM synchronous motor is supplied with direct current to effect a braking action.

30. A track-bound motor vehicle, comprising an electric machine constructed for use as holding brake, said electric machine having a rotor, a stator, and a control system to so control the operation of the electric machine that the position of the rotor in the stator remains constant when exposed to an external torque.

31. A method of operating a holding brake for a track-bound motor vehicle, comprising the steps of:
operating at least one electric machine as a holding brake, with the electric motor having a rotor and a stator; and
controlling the electric machine such that a position of the rotor in the stator remains constant when exposed to an external torque.

32. The method of claim 31, further comprising the step of adjusting the rotor to a desired position.

33. The method of claim 31, further comprising the step of determining an angular position of the rotor by a rotor position encoder.

34. The method of claim 31, further comprising the step of determining an angular position of the rotor on the basis of electric variables by means of a rotor position model.

35. The method of claim 34, wherein the angular position of the rotor is determined on the basis of an evaluation of magnetic asymmetries of the rotor.

36. The method of claim 34, wherein the angular position of the rotor is determined on the basis of position-dependent differences in inductance of the rotor.

37. The method of claim 31, further comprising the step of supplying power to the electric machine by means of a converter power section.

38. The method of claim 31, wherein the electric machine is a PM synchronous motor, and further comprising the step of supplying the stator of the PM synchronous motor with direct current to effect a braking action.
